(19) United States
(12) Patent Application Publication
(10) Pub. No.: US 2013/0043052 A1
(43) Pub. Date: Feb. 21, 2013

(54) HAMMER DRILL

(71) Applicants: Frantisek Harcar, Lipany (SK); Andreas Friedrich, Limburg (DE)

(72) Inventors: Frantisek Harcar, Lipany (SK); Andreas Friedrich, Limburg (DE)

(73) Assignee: BLACK & DECKER INC., Newark, DE (US)

(21) Appl. No.: 13/555,510

(22) Filed: Jul. 23, 2012

(30) Foreign Application Priority Data
Jul. 26, 2011 (GB) 1112825.3

(51) Int. Cl. B25D 17/24

(52) U.S. Cl. 173/162.2

(57) ABSTRACT

A hammer drill having a housing and a rear handle moveably mounted to a rear of the housing by means of at least one movement control mechanism is disclosed. A bellows is fixed to the handle and slidably mounted to a protrusion on the housing to prevent access to the movement control mechanism.

### CROSS-REFERENCE TO RELATED APPLICATIONS

This application claims priority, under 35 U.S.C. §119(a)-(d), to UK Patent Application No. GB 11 128 25.3 filed Jul. 26, 2011, the contents of which are incorporated herein by reference in its entirety.

### FIELD OF THE INVENTION

The present invention relates to a hammer drill, and in particular, a vibration dampening mechanism for a handle of a hammer drill.

### BACKGROUND OF THE INVENTION

A typical hammer drill comprises a body in which is mounted an electric motor and a hammer mechanism. A tool holder is mounted on the front of the body which holds a cutting tool, such as a drill bit or a chisel. The hammer mechanism typically comprises a slideable ram reciprocatingly driven by a piston, the piston being reciprocatingly driven by the motor via a set of gears and a crank mechanism or wobble bearing. The ram repeatedly strikes the end of the cutting tool via a beat piece. When the only action on the tool bit is the repetitive striking of its end by the beat piece, the hammer drill is operating in a hammer only mode.

Certain types of hammer drill also comprise a rotary drive mechanism which enables the tool holder to rotatingly drive the cutting tool held within the tool holder. This can be in addition to the repetitive striking of the end of the cutting tool by the beat piece (in which case, the hammer drill is operating in a hammer and drill mode) or as an alternative to the repetitive striking of the end of the cutting tool by the beat piece (in which case, the hammer drill is operating in a drill only mode).

EP1157788 discloses a typical hammer drill.

Hammer drills are supported by the operator using handles. In one type of hammer drill, there is one rear handle attached to the rear of the body of the hammer drill, at the opposite end of the body to where the tool holder is mounted. The operator pushes the cutting tool into a work piece by pushing the rear handle towards the body, which in turn pushes the body and the cutting tool towards the work piece.

A problem associated with hammer drills is the vibration generated by the operation of the hammer drill, and in particular, the vibration generated by the operation of the hammer mechanism. This vibration is transferred to the hands of the operator holding the handles of the hammer drill, particularly through the rear handle. This can result in the injury of the hands of the operator. As such, it is desirable to minimise the effect of vibration experienced by the hands of the operator. This is achieved by reducing the amount by which the handle vibrates.

There are two ways of reducing the amount by which the rear handle vibrates. The first method is to reduce the amount of vibration produced by the whole hammer drill. The second method is to reduce the amount of vibration transferred from the body of the hammer drill to the rear handle. The present invention relates to the second method.

EP1529603 discloses a dampening mechanism for a rear handle by which the amount of vibration transferred from the body to the handle is reduced.

The rear handle is slideably mounted on the body using connectors 230. Springs 220 bias the handle 202 rearwardly away from the housing 212, and which act to dampen vibration to reduce the amount transferred from the housing 212 to the handle 202. A movement co-ordination mechanism is provided, which comprises an axial 216, which interacts with the connectors 230 to ensure that the movement of the two ends of the handle are in unison.

The problem with the design of dampening mechanism disclosed in EP1529603 is that the movement co-ordination mechanism is located within the housing. As such, it takes up valuable space.

EP2018938 seeks to overcome this problem by placing the movement co-ordination mechanism in the handle.

However, in both EP1529603 and EP2018938, the designs of handle require a movement co-ordination mechanism which incurs extra cost and complexity.

In EP152603, there are provided two bars (230a, 230b) connected to the handle which slide within guides (232a, 232b) mounted on the housing. In EP2018938, there are provided two bars (24; 104) connected to the housing which slide within guides (26) mounted on the handle. In both designs, the amount of contact in the lengthwise direction between the bars and the guides remain constant at all times. The amount of contact is dependent on the length of the guide. This is regardless of the position of the handle versus the housing. As such, the amount of support for the bars against a bending force applied to the bars remains constant regardless of the amount of force applied to the handle to move it towards the housing. Only the position of the guides on the bars alters as the handle moves relative to the housing.

Furthermore, the guides are shown as making contact along the whole length of the part of the bars located inside of the guides. However, in reality, the inner surfaces of the guide and the external surfaces formed on the bar are not perfectly flat due to manufacturing tolerances and wear. Therefore, to ensure that the bars slide smoothly within the guides, the dimensions of the cross section of the bars are slightly less than that of the cross section of the passageways formed through the guides. This however, allows the bars to move by a small amount in a direction perpendicular to its longitudinal axis within the guide. This allows the handle to move sideways thus increasing the amount of vibration transferred to the handle.

EP 2289669 discloses a hammer drill in which a rear handle is moveably mounted on to the rear of a body via at least one movement control mechanism and which is capable of moving towards or away from the body, wherein each movement control mechanism comprises a first mount, a rod, having a longitudinal axis, rigidly connected at one of it ends to the first mount, and a second mount which slidingly engages with the rod at two distinct points only along its length to allow the rod to slide relative to the second mount in a direction parallel to the longitudinal axis whilst preventing the rod from moving relative to second mount in a direction perpendicular to longitudinal axis, wherein one mount is attached to the body and the other mount is attached to the rear handle. As shown in greater detail in FIG. 2, which shows a cross-sectional view of the connection between one end of handle 402 to body 404 of a hammer drill, the gap between the handle 402 and the body 404 is occupied by a bellows 400. The bellows 400 has first end second ends 406, 408, which are fixed to the body 404 and the handle 402 respectively. As the handle 402 moves towards and away from the body 404, the bellows 400 contracts or expands respectively to accommodate changes in the size of the gap and prevent access to the movement control mechanism between the handle and the body.

However, the arrangement of EP2289669 suffers from the drawback that expansion and contraction of the bellows 400 alter the biasing characteristics of the vibration damping mechanism as a whole, since the bellows acts as a spring, making it difficult and expensive to produce a handle assembly having the desired biasing characteristics, and the continual expansion and contraction of the bellows results in wear and tear.

### BRIEF SUMMARY OF THE INVENTION

Preferred embodiments of the present invention seek to overcome one or more of the above disadvantages.

According to the present invention there is provided a power tool comprising:
a housing;
a tool holder mounted to the housing for holding a cutting tool;
a hammer mechanism in the housing for imparting impacts to a cutting tool held by the tool holder;
a motor in the housing for driving the hammer mechanism;
a rear handle moveably mounted to a rear of the housing by means of at least one movement control mechanism comprising a respective first part mounted to one of the rear handle and housing, and a respective second part mounted to the other of the rear handle and housing and adapted to slidably engage said first part;
at least one biasing device for biasing the rear handle away from the housing; and
at least one cover device engaging said housing and said handle to prevent access to a respective said movement control mechanism, wherein at least one said cover device comprises a respective cover member having at least one end portion slidably engaging one of said housing and said rear handle.

By providing at least one said cover device comprising a respective cover member having at least one end portion slidably engaging one of said housing and said rear handle, this provides the advantage of minimising the influence of compression and expansion of the cover member on the characteristics of the corresponding biasing device and minimising wear and tear of the cover member by reducing the extent to which it needs to be compressed and expanded.

At least one said end portion may be fixed with respect to one of said housing or said rear handle.

At least one said end portion may be integrally formed with one of said housing or said rear handle.

At least one said cover device may have a compressible portion between first and second said end portions thereof.

### BRIEF DESCRIPTION OF THE DRAWINGS

A preferred embodiment of the invention will now be described, by way of example only and not in any limitative sense, with reference to the accompanying drawings, in which:

FIG. 1 shows a sketch of a side view of a hammer drill;

FIG. 2 shows a vertical cross section of part of a known handle assembly of a hammer drill; and

FIG. 3 shows a vertical cross section of part of a handle assembly of a hammer drill embodying the present invention.

### DETAILED DESCRIPTION OF THE INVENTION

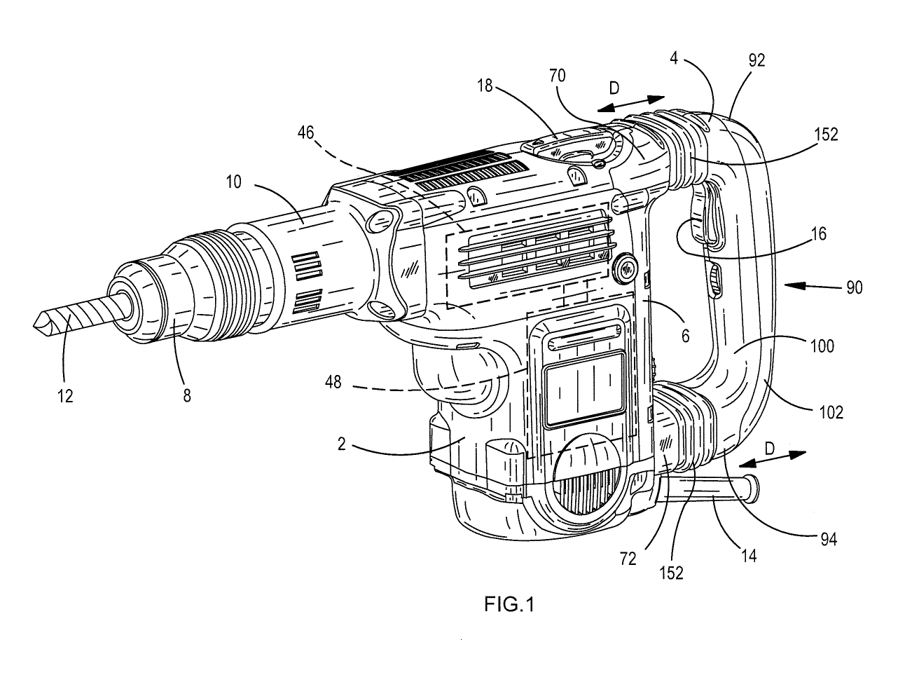

Referring to FIG. 1, a hammer drill comprises a body 2 having a rear handle 4 moveably mounted to the rear of the body 2. The rear handle 4 comprises a centre grip section 90 and two end connection sections 92; 94, one end connection section being attached to one end of the centre grip section, the other end connection section being connected to the other end of the centre grip section. The handle 4 is connected to the rear of the body 2 by the two end connection sections 92, 94. The rear handle is constructed from a plastic clam shell 100 and a rear end cap 102 which is attached to the clam shell 100 using screws (not shown). The rear of the body is formed by three plastic clam shells 6, 70, 72 which attach to each other and to the remainder of the body 2 using screws (not shown).

A tool holder 8 is mounted onto the front 10 of the body 2. The tool holder can hold a cutting tool 12, such as a drill bit. A motor (shown generally by dashed lines 48) is mounted within the body 2 which is powered by a mains electricity supply via a cable 14. A trigger switch 16 is mounted on the rear handle 4. Depression of the trigger switch 16 activates the motor in the normal manner. The motor drives a hammer mechanism (shown generally by dashed lines 46), which comprises a ram (not shown) reciprocatingly driven by the motor within a cylinder (not shown) which in turn strikes, via a beat piece (not shown), the end of the cutting tool 12. In addition, or alternatively, the motor can rotationally drive the tool holder 8 via a series of gears (not shown). A mode change mechanism (not shown) can switch the hammer drill between three modes of operation, namely hammer only mode, drill only mode or hammer and drill mode. A rotatable knob 18 is mounted on the top of the body 2. Rotation of the knob 18 changes the mode of operation of the hammer drill in well known manner.

The rear handle 4 can move in the direction of Arrow D in FIG. 1. The movement of handle 4 is controlled using two movement control mechanisms so that it moves linearly towards or away from the body 2 of the hammer drill, but is prevented from rotation relative to the body 2 of the hammer drill. Two helical springs (not shown) bias the rear handle 4 away from the body 2, and respective bellows 152 surround each spring and the movement control mechanisms between the clam shell 100 of the handle 4 and the clam shell 70, 72 of the rear of the body 2 to prevent the ingress of dust during use of the hammer.

Referring to FIG. 3, each bellows 152 has a first end 200, fixed to or integrally formed with the rear handle 4, and a second end 202 slidably mounted to the body 2. The second end 202 slidably surrounds a suitable part 204 of constant cross section provided on the body 2, to enable limited sliding movement of the handle 4 relative to the body 2 without significant compression or expansion of a central part 206 of the bellows 152 between the first and second ends 200, 204. The handle 4 can therefore move relative to the body 2 to enable vibrations generated by the hammer drill to be damped, without significant compression or expansion of the bellows 152, thereby minimising wear and tear and the influence of the bellows 152 on the biasing characteristics of the movement control mechanism of the handle 4.

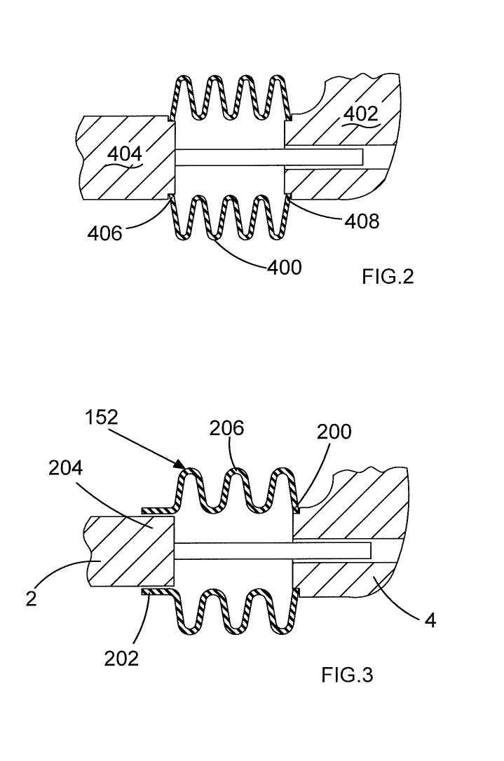

In the case of vibrations of significant amplitude, the second end 202 of the bellows 152 abuts a widened portion (not shown) on the part 204 on body 2, and further vibration is damped by compression and expansion of the central part 206 of the bellows 152. However, because the bellows 152 is compressed and expanded to a significantly lesser extent than in the case of the arrangement shown in FIG. 2, the bellows 152 can be constructed of more robust material, and wear and tear of the bellows 152 is minimised.

It will be appreciated by persons skilled in the art that the above embodiment has been described by way of example only and not in any limitative sense, and that various alterations and modifications are possible without departure from the scope of the invention as defined by the appended claims.

1. A power tool comprising:
a housing;
a tool holder mounted to the housing for holding a cutting tool;
a hammer mechanism in the housing for imparting impacts to a cutting tool held by the tool holder;
a motor in the housing for driving the hammer mechanism;
a rear handle moveably mounted to a rear of the housing by means of at least one movement control mechanism comprising a respective first part mounted to one of the rear handle and housing, and a respective second part mounted to the other of the rear handle and housing and adapted to slidably engage said first part;
at least one biasing device for biasing the rear handle away from the housing; and
at least one cover device engaging said housing and said handle to prevent access to a respective said movement control mechanism, wherein at least one said cover device comprises a respective cover member having at least one end portion slidably engaging one of said housing and said rear handle.

2. The power tool of claim 1, wherein at least one said end portion is fixed with respect to one of said housing or said rear handle.

3. The power tool of claim 1, wherein at least one said end portion is integrally formed with one of said housing or said rear handle.

4. The power tool of claim 1, wherein at least one said cover device has a compressible portion between first and second said end portions thereof.
